(19) United States
(12) Patent Application Publication
(10) Pub. No.: US 2016/0239561 A1
(43) Pub. Date: Aug. 18, 2016

(54) SYSTEM AND METHOD FOR OBTAINING INFORMATION, AND STORAGE DEVICE

(71) Applicant: NATIONAL YUNLIN UNIVERSITY OF SCIENCE AND TECHNOLOGY, Yunlin (TW)

(72) Inventors: Chuen-Min HUANG, Douliu City (TW); Ya-Che LI, Taoyuan City (TW); Cheng-Yi WU, Tainan City (TW); Po-Hung CHEN, Kaohsiung City (TW); Jia-Wun LUO, New Taipei City (TW); Wei-Ching HSIAO, Kaohsiung City (TW); Ching-Che LI, Tainan City (TW)

(21) Appl. No.: 14/837,692

(22) Filed: Aug. 27, 2015

(30) Foreign Application Priority Data
Feb. 12, 2015 (TW) 104104845

(51) Int. Cl. G06F 17/30

(52) U.S. Cl. CPC G06F 17/30669; G06F 17/30654; G06F 17/3064; G06F 17/30684; G06F 17/30705; G06F 17/30958

(57) ABSTRACT

A method for obtaining information includes the following steps of: retrieving at least a first text file from a first server; analyzing the first text file to generate at least one extracted term; accessing a second server containing a plurality of second text files; comparing the extracted term with the second text files; and when at least one of the second text files contains the extracted term, executing a generalized term extraction procedure, a synonym extraction procedure, or a homonym extraction procedure so as to correspondingly generate generalized term, synonym or homonym information.

### CROSS REFERENCE TO RELATED APPLICATIONS

This Non-provisional application claims priority under 35 U.S.C. §119(a) on Patent Application No(s). 104104845 filed in Taiwan, Republic of China on Feb. 12, 2015, the entire contents of which are hereby incorporated by reference.

### BACKGROUND OF THE INVENTION

1. Field of Invention

The present invention relates to a system and method for obtaining information and, in particular, to a system and method for obtaining generalized term information, synonym information or homonym information.

2. Related Art

In most articles, especially in Chinese articles, the repeated terms are usually shown as abbreviations. For example, the term “ [symbol] ” (Taiwan Railways Administration, pinyin: tai wan tie lu ju) has an abbreviation of “ [symbol] ” (pinyin: tai tie ju). Moreover, the generic terms may increase and change with the history, culture and frequency. For instance, after the popularity of the famous “Facebook”, people in Taiwan will simply call it as “FB” or “ [symbol] (pinyin: lian shu)”. The created synonyms and abbreviations can improve the communication efficiency and convenience, and further enrich the emotion expression. However, this is a difficult issue for the word/terminology process, which may fatally affect the searching results of all search engines.

For example, when a user wants to know about the term “ [symbol] ” (army, pinyin: san jun) and googles it, the search results show a lot of information related to “ [symbol] ” (Tri-service general hospital, pinyin: san jun zong yi yuan). Unfortunately, most of these results are not the desired answers for the user. Accordingly, the user may spend a lot of time to find out the desired information from the search results. This and similar problems exist in many situations. In brief, these generalized terms and abbreviations will decrease the searching efficiency of the search engine, thereby increasing the time spent of the user to discover the desired answers.

### SUMMARY OF THE INVENTION

In view of the foregoing description, this invention is to provide a system, a method and an application for obtaining information that can improve the searching efficiency, thereby providing correct information with respect to the query term(s).

The present invention discloses a system for obtaining information, which includes a term creating unit, a term mapping unit, a database group and a user interface unit. The term creating unit links to a first server, which contains at least one first text file, and analyzes the first text file to generate at least one extracted term. The term mapping unit links to the term creating unit and a second server, which contains a plurality of second text files, and compares the extracted term with the second text files to determine to execute a generalized term extraction procedure, a synonym extraction procedure, or a homonym extraction procedure so as to correspondingly generate generalized term information, synonym information or homonym information. The database group links to the term creating unit and the term mapping unit, and stores the extracted term and the generated generalized term, synonym or homonym information. The user interface unit links to the database group ad receives a query term. When the query term matches the extracted term, the user interface unit provides the generalized term, synonym or homonym information.

In addition, this invention also discloses a method for obtaining information, which includes the following steps of: retrieving at least a first text file from a first server; analyzing the first text file to generate at least an extracted term; accessing a second server containing a plurality of second text files; comparing the extracted term with the second text files; and when at least one of the second text files contains the extracted term, executing a generalized term extraction procedure, a synonym extraction procedure, or a homonym extraction procedure so as to correspondingly generate generalized term information, synonym information or homonym information.

In one embodiment, the method for obtaining information further includes the steps of: when receiving a query term, comparing the query term to the extracted term to determine whether the query term matches the extracted term or not; and when the query term matches the extracted term, providing the generalized term, synonym or homonym information.

In one embodiment, the first server is a news server, and the first text file is a source code file of a news webpage.

In one embodiment, the step of generating the extracted term at least includes: retrieving a text content of the first text file; and executing a segmentation process with regard to the text content of the first text file so as to generate the extracted term.

In one embodiment, the segmentation process includes a lexicon segmentation method, a statistical segmentation method or a hybrid segmentation method.

In one embodiment, the second server is an open edit information server, and the second text file is an editable information webpage.

In one embodiment, the method for obtaining information further includes the steps of: determining whether the extracted term contains a number in a Chinese word; and if yes, executing the generalized term extraction procedure.

In one embodiment, when the text content of one of the second text files contains the extracted term, the generalized term extraction procedure includes: searching a location of the extracted term in the second text file; determining whether at least one specific character exists behind the extracted term in the second text file; if yes, determining whether the total number of the specific characters behind the extracted term matches the number in the Chinese word; and when the total number of the specific characters matches the number in the Chinese words, extracting terms in front of and behind the specific characters as the generalized term information.

In one embodiment, the specific character is a Chinese back sloping comma. In one embodiment, the step of determining whether the total number of the specific characters behind the extracted term matches the number in the Chinese word is to determine whether the total number of the terms in front of and behind the Chinese back sloping comma equals the number in the Chinese words minus one.

In one embodiment, when the text content of one of the second text files contains the extracted term, the synonym extraction procedure includes: searching a location of the extracted term in the second text file; and extracting the first term of the paragraph containing the extracted term as the synonym information.

In one embodiment, when the text content of one of the second text files contains the extracted term, the synonym extraction procedure includes: searching a location of the extracted term in the second text file; and extracting boldfaced words in the paragraph containing the extracted term as the synonym information.

In one embodiment, when the text content of one of the second text files contains the extracted term, the synonym extraction procedure includes: extracting a term located at a specific position in the second text file as the synonym information according to an editing rule of the second text file.

In one embodiment, when there are more than one of the second text files containing the extracted term, the homonym extraction procedure includes: processing the contents of the multiple second text files according to a term combination rule so as to generate the homonym information.

In one embodiment, the method for obtaining information further includes a step of: modifying the generalized term, synonym or homonym information according to an agree score; or modifying the generalized term, synonym or homonym information according to an input content.

In addition, the present invention further discloses a storage device storing an application, which is executed by a computer for performing the following steps of: retrieving at least a first text file from a first server; analyzing the first text file to generate at least an extracted term; accessing a second server containing a plurality of second text files; comparing the extracted term with the second text files; and when at least one of the second text files contains the extracted term, executing a generalized term extraction procedure, a synonym extraction procedure, or a homonym extraction procedure so as to correspondingly generate generalized term information, synonym information or homonym information.

Moreover, this invention also discloses a method for obtaining information, which includes the following steps of: receiving a query term; and when the query term contains a number in a Chinese word, providing generalized term information obtained according to a generalized term extraction procedure.

In one embodiment, the method for obtaining information further includes a step of: when the query term does not contain a number in a Chinese word, providing synonym information or homonym information obtained according to a synonym extraction procedure or a homonym extraction procedure.

As mentioned above, the method for obtaining information of this invention can retrieve at least one extracted term from the first text file of a first server, compare the extracted term with the second text files of a second server, and then execute a generalized term extraction procedure, a synonym extraction procedure, or a homonym extraction procedure according to the comparing result. As a result, this invention can improve the searching efficiency, thereby providing correct information with respect to the query term(s).

### BRIEF DESCRIPTION OF THE DRAWINGS

The invention will become more fully understood from the detailed description and accompanying drawings, which are given for illustration only, and thus are not limited to the present invention, and wherein:

FIG. 1 is a block diagram showing a system for obtaining information according to a preferred embodiment of the invention;

FIG. 2 is a flow chart of a method for obtaining information according to a preferred embodiment of the invention;

FIG. 3 is a flow chart showing the details of a step S24 of FIG. 2;

FIG. 4 is a schematic diagram showing a table including extracted terms;

FIG. 5 is a flow chart showing the details of a step S30 (a generalized term extraction procedure) of FIG. 2;

FIG. 6A is a schematic diagram showing the searching result according to a first embodiment of the invention;

FIG. 6B is a schematic diagram showing the searching result according to a second embodiment of the invention;

FIG. 7 is a flow chart showing the steps of executing a synonym extraction procedure according to a first embodiment of the invention;

FIG. 8 is a flow chart showing the steps of executing a synonym extraction procedure according to a second embodiment of the invention;

FIG. 9 is a flow chart showing the steps of executing a synonym extraction procedure according to a third embodiment of the invention;

FIG. 10A is a schematic diagram showing an information box;

FIG. 10B is a flow chart showing the steps of executing a synonym extraction procedure according to a fourth embodiment of the invention;

FIG. 11 is a flow chart showing the steps of executing a homonym extraction procedure according to a preferred embodiment of the invention;

FIG. 12A is a schematic diagram showing a displayed screen of the agree scores according to a preferred embodiment of the invention;

FIG. 12B is a schematic diagram showing a displayed screen of adding terms according to a preferred embodiment of the invention; and

FIG. 12C is a schematic diagram showing the generalized term information after adding the new terms according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

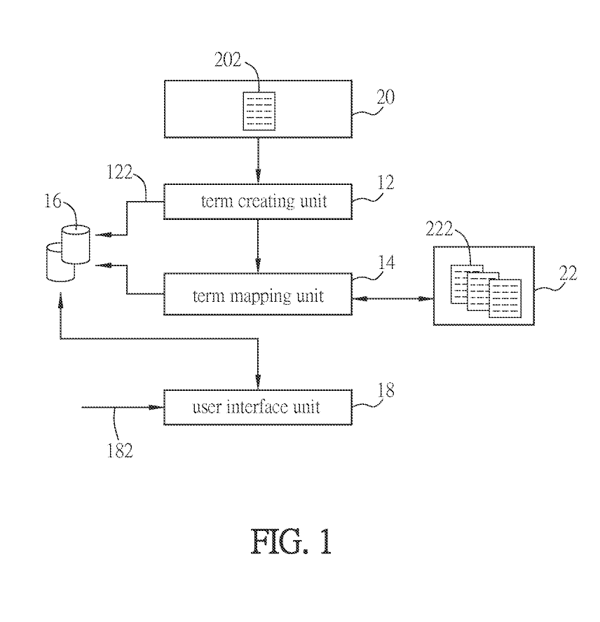

FIG. 1 is a block diagram showing a system 1 for obtaining information according to a preferred embodiment of the invention. Referring to FIG. 1, the system 1 includes a term creating unit 12, a term mapping unit 14, a database group 16, and a user interface unit 18. To be noted, the functional blocks of FIG. 1 can be carried out by software, firmware and/or hardware (e.g. computers, chips, mobile devices, CPU, and the likes).

As shown in FIG. 1, the term creating unit 12 links to a first server 20, which contains at least one first text file 202. In this embodiment, the first server 20 is a news server, such as the server of Yahoo!News. Correspondingly, the first text file 202 is the source code file of a news webpage.

In addition, the term mapping unit 14 links to a second server 22, which contains a plurality of second text files 222. In some embodiments, the second server 22 is an open-edited information server, such as the Wikipedia server. Correspondingly, these second text files 222 can be multiple editable information webpages, such as the information webpages of the Wikipedia. Although the following embodiments are all based on Wikipedia, it should be known that the second server 22 can also be another kind of server, such as the Bidu server, Wikipedia Taiwan server, and the likes.

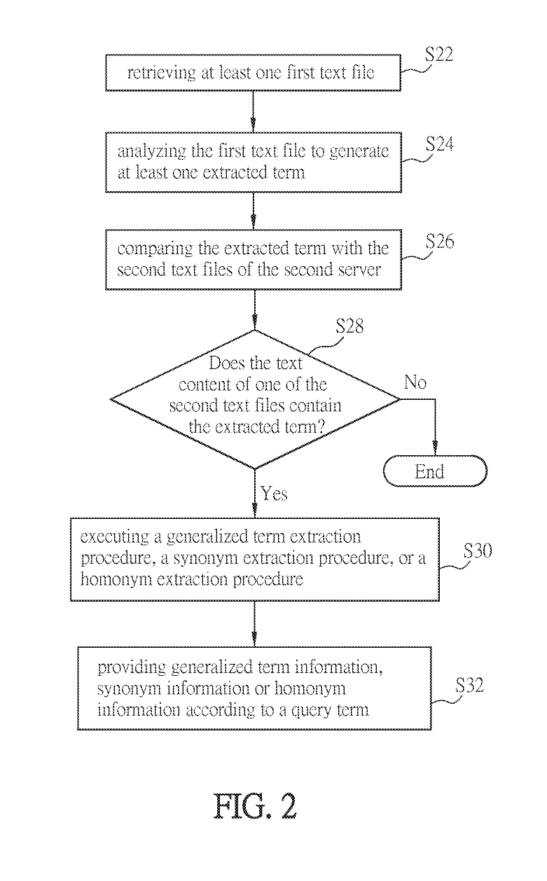

FIG. 2 is a flow chart of a method for obtaining information according to a preferred embodiment of the invention. With reference to FIGS. 1 and 2, the term creating unit 12 links to the first server 20 and then retrieves at least one first text file 202 (step S22). Afterwards, the term creating unit 12 analyzes the first text file 202 to generate at least one extracted term 122 (step S24).

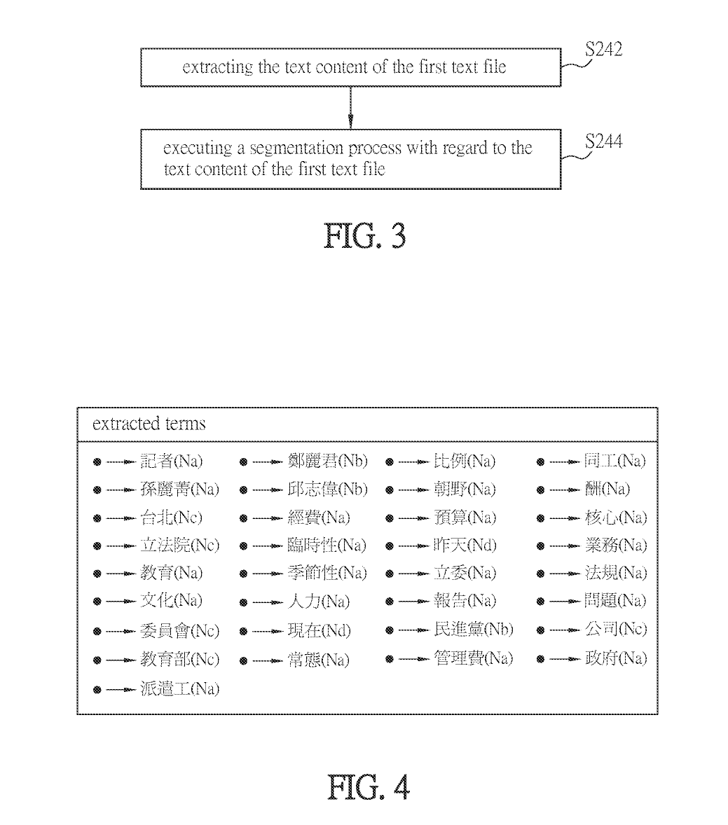

FIG. 3 is a flow chart showing the details of the step S24 of FIG. 2. With reference to FIG. 3, after retrieving the first text file 202, the term creating unit 12 extracts the text content of the first text file 202 (step S242). Then, the term creating unit 12 executes a segmentation process with regard to the text content of the first text file 202 so as to generate the extracted term (step S244).

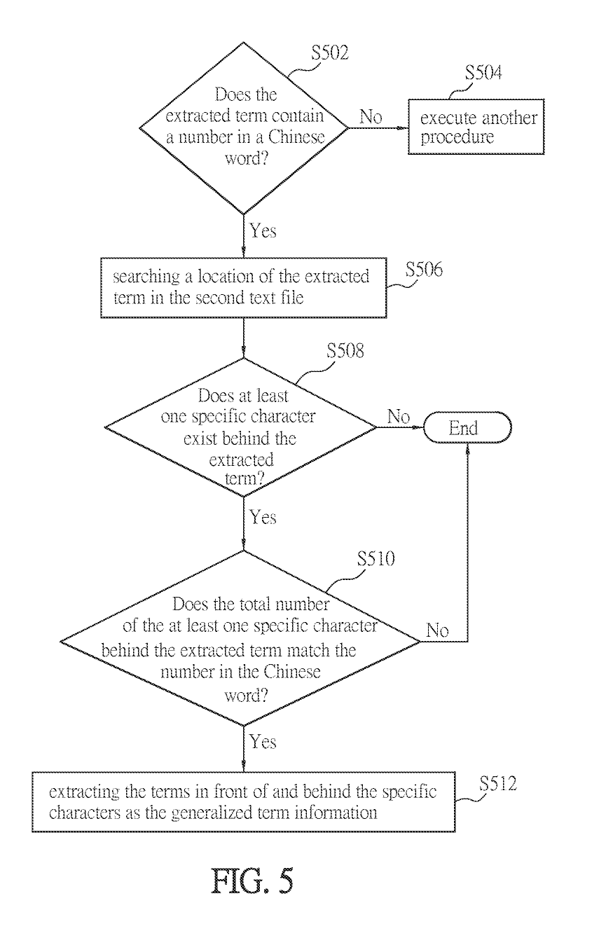

In FIG. 3, the step of executing a segmentation process (step S244) can be carried out by a lexicon segmentation method, a statistical segmentation method or a hybrid segmentation method. In some embodiments, the step S244 can be performed to execute a segmentation process with regard to the text content of the first text file 202 based on the CKIP segmentation system invented by Academia Sinica (Taiwan), thereby generating a plurality of extracted terms 122. FIG. 4 is a schematic diagram showing a table including a plurality of extracted terms. In this case, the extracted terms listed in FIG. 4 are obtained by executing a segmentation process with regard to the source code of a news webpage published on Yahoo!News Taiwan (Title: “ [symbol] [symbol] ” (The high proportion of dispatch workers, the Ministry of Education was scolded, pinyin: pai qian gong bi li guo gao jiao yu bu ai hong), dated Oct. 25, 2013). In some embodiments, after retrieving the extracted terms 122, the retrieved extracted terms 122 are then stored in the database group 16. Herein, the database group 16 can be either one or both of a local storage device and a remote (cloud) storage device.

Referring to FIGS. 1 and 2 again, the term mapping unit 14 retrieves the extracted term 122 from the database group 16 and then compares the extracted term 122 with the second text files 222 of the second server 22 (step S26). Next, the step S28 is to check whether the content of at least one second text file 222 of the second server 22 contains the extracted term 122. If yes, the step S30 is executed to execute a generalized term extraction procedure, a synonym extraction procedure, or a homonym extraction procedure so as to correspondingly generate generalized term information, synonym information or homonym information. After generating the generalized term, synonym or homonym information, the generated information can be stored in the database group 16. To be noted, the generated information can be stored in the database storing the extracted term or a different database. In addition, when the user interface unit 18 receives a query term 182, which is inputted by a user, the step S32 is executed to provide generalized term, synonym or homonym information according to the query term 182.

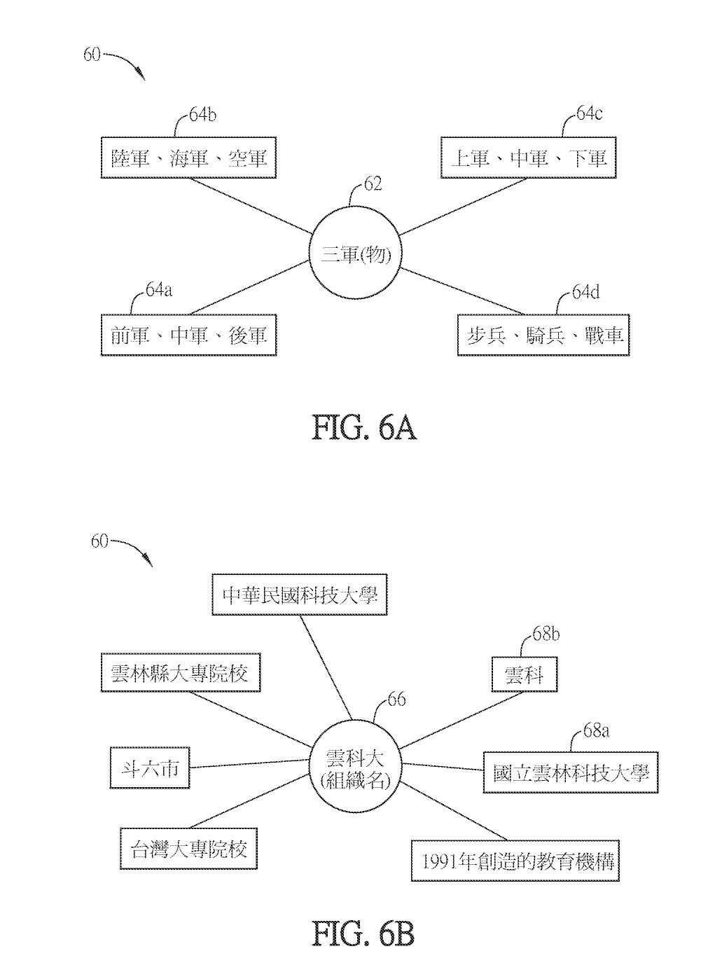

FIG. 5 is a flow chart showing the details of the step S30 of FIG. 2, which is to execute a generalized term extraction procedure. Referring to FIG. 5, when the step S28 of FIG. 2 determines the content of one of the second text files contains the extracted term, the step S502 of FIG. 5 is executed to determine whether the extracted term contains a number in a Chinese word. Then, if the step S502 determines that the extracted term contains a number in a Chinese word, the step S506 is executed to search a location of the extracted term in the second text file and then execute the generalized term extraction procedure.

Afterwards, the step S508 is executed to determine whether at least one specific character exists behind the extracted term. In this embodiment, the specific character is, for example, “ [symbol] ” (a Chinese back sloping comma), “ [symbol] ” (or, pinyin: huo), “ [symbol] ” (and, pinyin: yi ji), or “ [symbol] ” (and, pinyin: he). If the step S508 determines that at least one of the above-mentioned specific characters exists behind the extracted term of the second text file, the step S510 is executed to determine whether the total number of the specific characters behind the extracted term matches the number in the Chinese word. To be noted, to determine whether the total number of the specific characters matches the number in the Chinese word is not restricted to determine whether the total number of the specific characters (Chinese back sloping commas) “is equal to” the number in the Chinese word. In general, the total number of the specific characters (the consecutive Chinese back sloping commas in the text content) is equal to the number in the Chinese word minus one. This embodiment will be further described in details in the following description.

If the step S510 determines that the total number of the specific characters matches the number in the Chinese word, the step S512 is executed to extract all the terms in front of and behind the specific characters (the consecutive Chinese back sloping commas) as the generalized term information.

For example, when the extracted term 122 is “ [symbol] ” (army, pinyin: san jun), the term mapping unit 14 determines the extracted term 122 contains a number in a Chinese word, “ [symbol] ” (three, pinyin: san). Accordingly, the term mapping unit 14 starts to execute a generalized term extraction procedure so as to search the Wikipedia server and find out the webpages containing and/or related to the term “ [symbol] ”. Then, this procedure is to search the location of the term “ [symbol] ” from the searched webpage, and then determine whether at least one Chinese back sloping comma exists behind the term “ [symbol] ”.

In practice, the searched webpage containing the term “ [symbol] ” (the matched second text file 222) includes the following description: “ [symbol] [symbol] [symbol] ” (army generally includes a senior army, an intermediate army and a lower army; pinyin: san jun chang cheng wei shang jun zhong jun xia jun).

In this case, the number of the Chinese back sloping comma “ [symbol] ” existed behind the term “ [symbol] ” is 2 (equal to 3−1). Accordingly, it is determined that the total number of the at least one Chinese back sloping comma (2) behind the extracted term matches the number in the Chinese word (3). As a result, the term mapping unit 14 extracts the terms (“ [symbol] ”, “ [symbol] ” and “ [symbol] ”) in front of and behind the Chinese back sloping commas (“ [symbol] ”) as the generalized term information and then stores the extracted generalized term information in the database group 16.

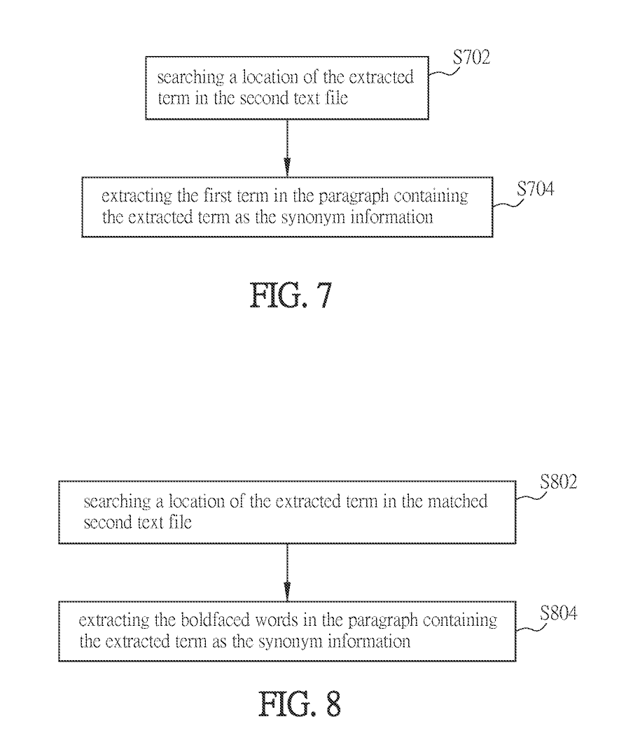

Referring to FIG. 1 again, after receiving the query term 182 inputted by the user, the user interface unit 18 determines whether the query term 182 matches the extracted term 122 of the database group 16. In this case, if the user inputs the term “ [symbol] ” in the searching page 60 as the query term 182, the user interface unit 18 will show the above-mentioned generalized term information as shown in FIG. 6A. In FIG. 6A, the term 62 is the query term inputted by the user, and the terms 64a, 64b, 64c and 64d are the above-mentioned generalized term information. Accordingly, the user can quickly search the correct information with respect to the query term.

In one embodiment of the invention, the user interface unit 18 is a webpage browser such as Chrome, Firefox, Safari, IE or the likes. However, in other embodiments, the system for obtaining information can be a plug-in module or software cooperating with the above-mentioned webpage browser.

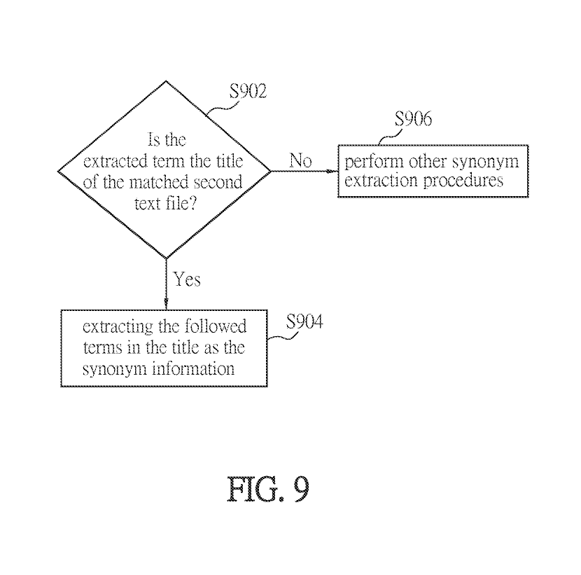

Please referring to FIG. 5, if the step S502 determines that the extracted term does not contain a number in a Chinese word, the step S504 is to execute another procedure such as the synonym extraction procedure or the homonym extraction procedure. FIG. 7 is a flow chart showing the steps of executing a synonym extraction procedure according to a first embodiment of the invention. As shown in FIG. 7, when the step S28 of FIG. 2 determines that the text content of one of the second text files contains the extracted term and the step S502 of FIG. 5 determines that the extracted term does not contain a number in a Chinese word, the step S702 is executed to search a location of the extracted term in the second text file. Then, the step S704 is to extract the first term in the paragraph containing the extracted term as the synonym (synonym information).

For example, when the extracted term 122 of FIG. 1 is “ [symbol] ” (NYU, pinyin: yun ke da), the term mapping unit 14 searches the second server 22 (e.g. a Wikipedia server) to obtain a qualified second text file 222, which is a webpage containing the following description: “ [symbol] [symbol] [symbol] [symbol] . . . ” (National Yunlin University of Science and Technology, which is also called for short as NYU or Yun Tech, and formerly known as National Yunlin Technical College; pinyin: guo li yun lin ke ji da xue, jian cheng yun ke da huo yun ke. Qian shen wei guo li yun lin ji shu xue yuan.)

Then, the term mapping unit 14 extracts the first term of the paragraph (as the above Chinese paragraph) containing the extracted term 122 as the synonym information. In this case, the term “ [symbol] ” (National Yunlin University of Science [symbol] and Technology; pinyin: guo li yun lin ke ji da xue) is extracted as the synonym information.

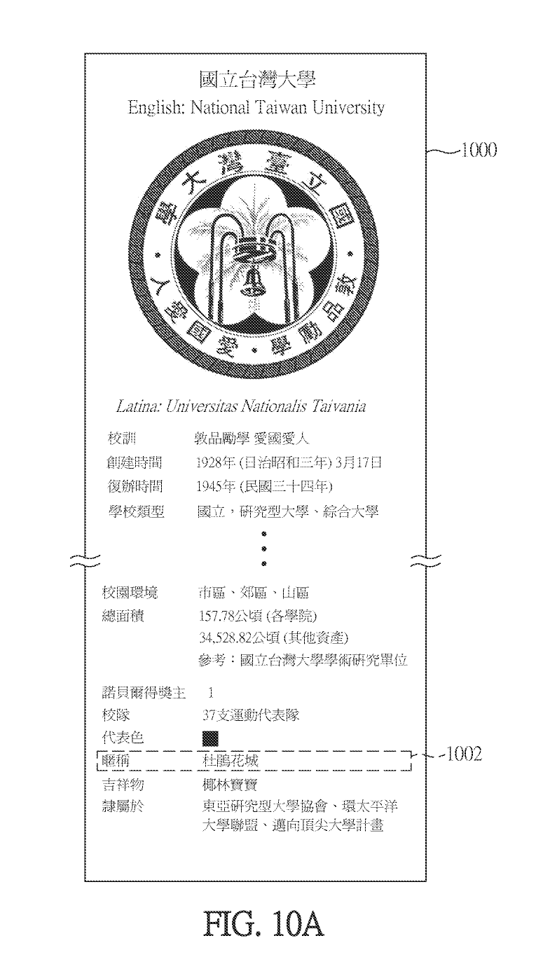

FIG. 8 is a flow chart showing the steps of executing a synonym extraction procedure according to a second embodiment of the invention. Referring to FIG. 8, in the synonym extraction procedure of this embodiment, the step S802 is executed to search a location of the extracted term 122 in the matched second text file 222. In addition, since the term description and the abbreviation(s) thereof are shown in boldfaced words. Accordingly, after retrieving the location of the extracted term, the step S804 is executed to extract the boldfaced words in the paragraph containing the extracted term as the synonym information. In the above example, the extracted term 122 is “ [symbol] ” (NYU, pinyin: yun ke da), so that the term mapping unit 14 extracts the boldfaced words in the paragraph containing the extracted term, including the terms “ [symbol] ” (National Yunlin University of Science and Technology; pinyin: guo li yun lin ke ji da xue) and “ [symbol] ” (Yun Tech, pinyin: yun ke). As a result, the term mapping unit 14 will extract a combination of these boldfaced words as the synonym information.

In other embodiments, the synonym extraction procedure may further include a step of: extracting a term located at a specific position in the matched second text file as the synonym information according to an editing rule of the second text file.

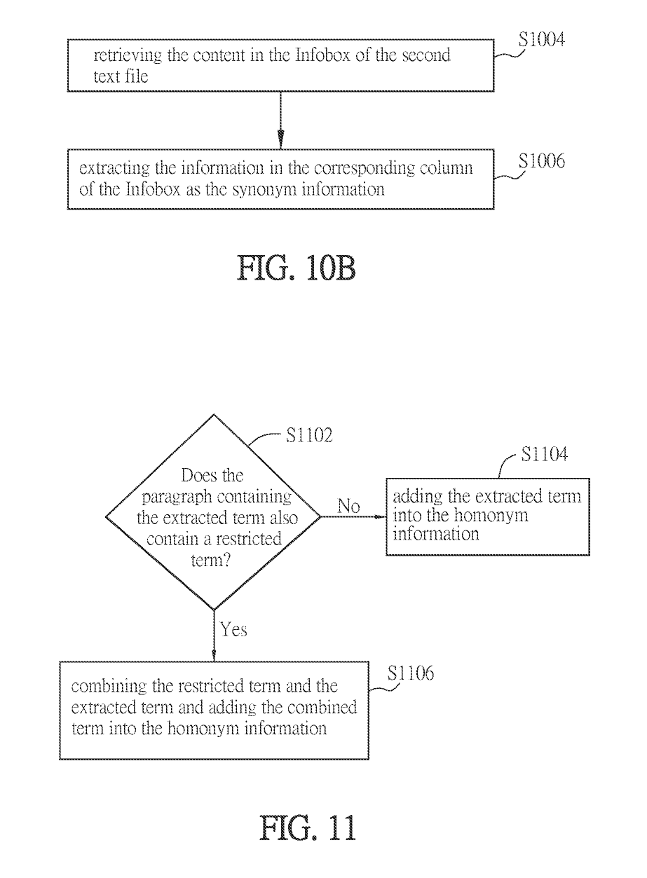

FIG. 9 is a flow chart showing the steps of executing a synonym extraction procedure according to a third embodiment of the invention. In Wikipedia Taiwan, the term of an organization (in Chinese) is usually followed by the English translation thereof (some terms have no English translations) and the abbreviation of the organization. In this case, the followed abbreviation can be used as the synonym information. In this embodiment, the term mapping unit 14 firstly executes the step S902 to determine whether the extracted term 122 is or is contained in the title of the matched second text file 222. If yes, the step S904 is executed to extract the followed terms in the title as the synonym information. On the contrary, if not, the step S906 is executed to perform other synonym extraction procedures.

For example, when the extracted term 122 is “ [symbol] ” (National Yunlin University of Science and Technology; pinyin: guo li yun lin ke ji da xue), the term mapping unit 14 can find the matched second text file 222 as shown above and determine the extracted term 122 is the title of the matched second text file 222. Accordingly, the term mapping unit 14 extracts the following term, such as “ [symbol] [symbol] ” (NYU, pinyin: yun ke da) and “ [symbol] ” (Yun Tech, pinyin: yun ke), as the synonym information.

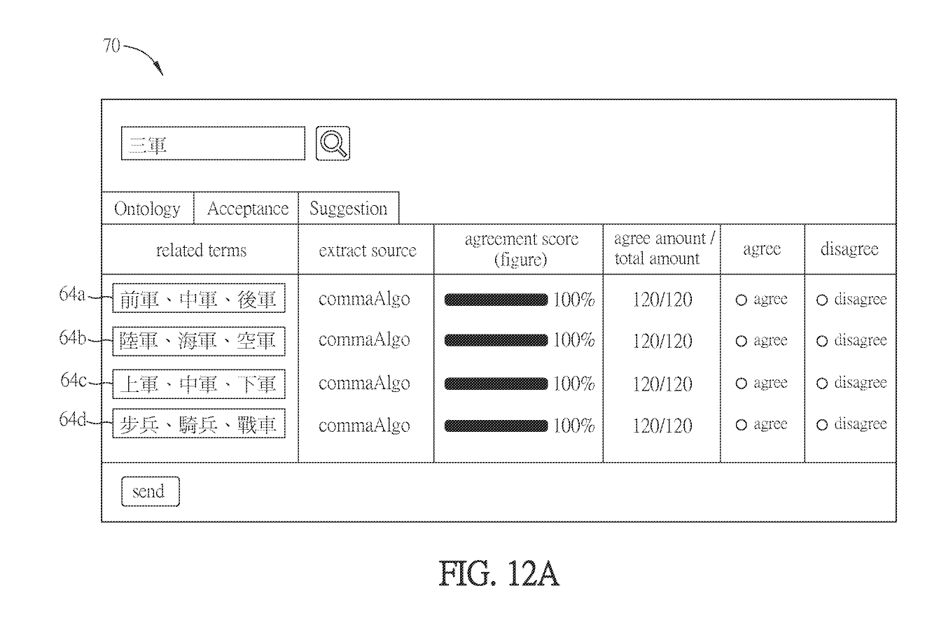

In addition, after examining the editing structure of Wikipedia, it is discovered that the Wikipedia uses Infobox to record a lot of structural information (as shown in FIG. 10A). Accordingly, the synonym extraction procedure can be performed as shown in FIG. 10B. Referring to FIG. 10B, the step S1004 is to retrieve the content in the Infobox (see FIG. 10A) of the second text file 222 (the related webpage). Then, the step S1006 is executed to extract the information in the corresponding column of the Infobox as the synonym information. For example, FIG. 10A shows an Infobox 1000 of a webpage related to “ [symbol] ” (National Taiwan University; pinyin: guo li tai wan da xue). In this embodiment, the term mapping unit 14 extracts the “nickname” column in the Infobox 1000 (the column labeled by the block 1002), which is “ [symbol] ” (Azaleas Town; pinyin: dujuan hua cheng), as the synonym information.

The above embodiments disclose the steps of several synonym extraction procedures. This invention can execute one or the combination of the above mentioned embodiments to perform the synonym extraction procedure. In addition, those skilled persons in the art can execute other synonym extraction procedures without departing the spirit of the invention.

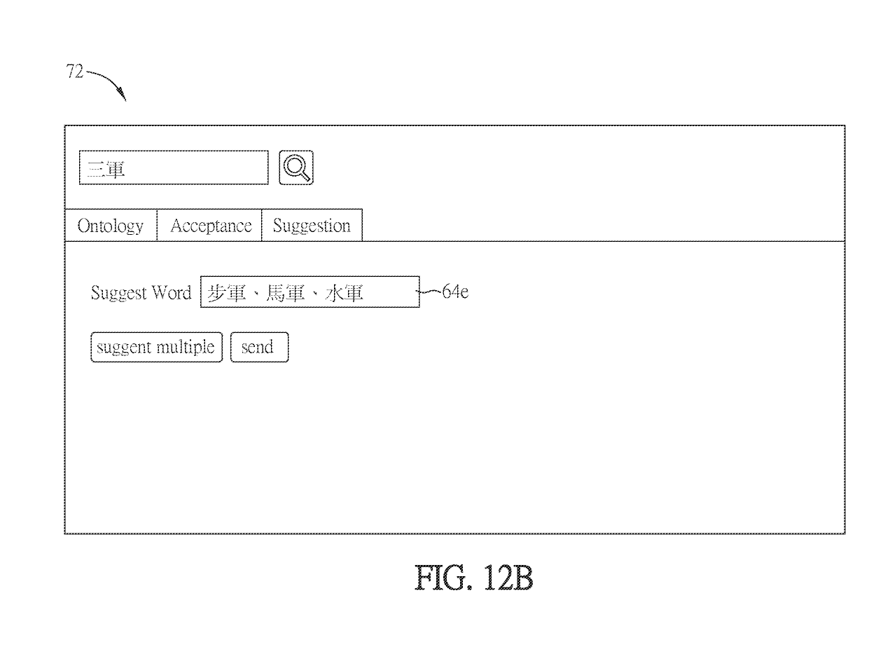

In addition, when the term mapping unit 14 determines that more than one second text file 222 contains the extracted term 122, a homonym extraction procedure will be executed. In this embodiment, the term mapping unit 14 processes the contents of all matched second text files according to a term combination rule so as to generate the homonym information. FIG. 11 is a flow chart showing the steps of executing a homonym extraction procedure according to a preferred embodiment of the invention. Referring to FIG. 11, when the term mapping unit 14 determines that more than one second text file 222 contains the extracted term 122, the step S1102 is executed to determine whether the paragraph of each matched second text file 222 containing the extracted term 122 also contains a restricted term for restricting the extracted term 122. If there is no restricted term exist, the step S1104 is executed to add the extracted term 122 into the homonym information.

On the contrary, if the paragraph of the matched second text file 222 containing the extracted term 122 also contains a restricted term, the step S1106 is executed to combine the restricted term and the extracted term 122 and add the combined term into the homonym information.

For example, when the extracted term 122 is “ [symbol] ” (pinyin: xiao tian tian), the term mapping unit 14 searches the Wikipedia Taiwan server and finds out the webpage relating to a Japanese historical romance novel, manga, and anime series and the webpage relating to a Taiwanese performer. In the webpage containing the term “ [symbol] ”, which relates to a Japanese historical romance novel, manga, and anime series, the paragraph containing the extracted term 122 does not include any restricted term. Accordingly, the term mapping unit 14 directly adds the term “ [symbol] [symbol] ” into the homonym information. Alternatively, if the preset restricted terms include “ [symbol] ” (mganga; pinyin: man hua) or “ [symbol] ” (anime (cartoon); pinyin: ka tong), the term mapping unit 14 can find corresponding restricted term in the paragraph. In this case, the term mapping unit 14 will add the term “ [symbol] ” (manga Candy Candy; pinyin: man hua xiao tian tian) and/or “ [symbol] ” (anime (cartoon) Candy Candy; pinyin: ka tong xiao tian tian) into the homonym information.

Similarly, if the restricted terms include “ [symbol] ” (performer; pinyin: yi ren), the term mapping unit 14 can find this restricted term from the paragraph containing the extracted term 122 in the webpage relating the containing a Taiwanese performer. Accordingly, the term mapping unit 14 adds the term “ [symbol] ” (performer; pinyin: yi ren xiao tian tian) into the homonym information. In this case, the homonym information contains the terms “ [symbol] ” and “ [symbol] ”, or the terms “ [symbol] ” (and/or “ [symbol] ”) and “ [symbol] ”.

FIG. 6B is a schematic diagram showing the searching result according to a second embodiment of the invention. Referring to FIG. 1 and the step S32 of FIG. 2 in view of FIG. 6B, when a user inputs the term “ [symbol] ” in the searching page 60 as the query term 66, the user interface unit 18 provides the synonym information 68a or 68b. Of course, if there are multiple second text files 222 contain the query term 66, the user interface unit 18 also provides the related synonym information as mentioned above.

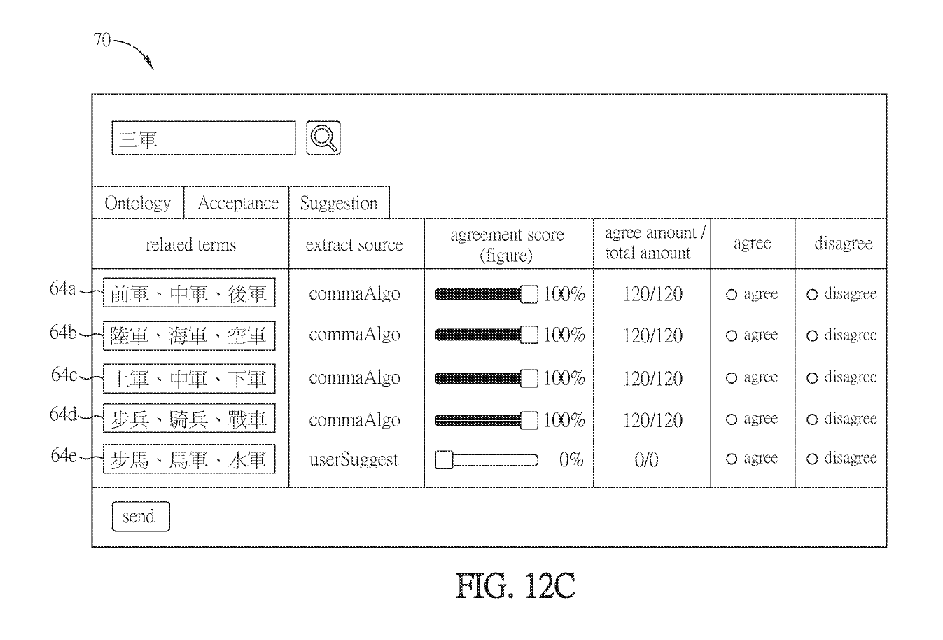

In order to improve the correction of the searching result, some embodiments of the invention may provide an agreement score mechanism for achieving the user interaction purpose. FIG. 12A is a schematic diagram showing a displayed screen of the agreement scores according to a preferred embodiment of the invention. In view of FIG. 12A, the user interface unit 18 provides an agreement score webpage 70 for user interaction. In the following embodiment, the query term is “ [symbol] ” (army, pinyin: san jun). In this case, the agreement score webpage 70 lists [symbol] all terms of the corresponding generalized term information, such as the terms 64a, 64b, 64c and 64d. Accordingly, the agreement scores of the terms will be continuously recalculated based on new inputs. When the agreement score of one of these terms (e.g. the term 64a) is lower than a threshold value, the term 64a will be removed from the generalized term list. This operation can also be applied to the above mentioned synonym information and homonym information, so the detailed descriptions thereof will be omitted.

Besides, some embodiments of the invention allow the user to add new terms into the generalized term, synonym and homonym information (list). FIG. 12B is a schematic diagram showing a displayed screen of adding terms according to a preferred embodiment of the invention. Referring to FIG. 12B, in an adding term webpage 72, the suggested words 64e (“ [symbol] ” (infantry, cavalry, navy; pinyin: bu jun, ma jun, shui jun)) are extracted and added to the generalized term information corresponding to the query term “ [symbol] ”. Accordingly, the generalized term information corresponding to the query term “ [symbol] ” further contains the term 64e (as shown in FIG. 12C). Similarly, the added term 64e can be evaluated by users to determine whether it should be remained in or removed from the generalized term information. In brief, the contents of the generalized term, synonym and homonym information can not only be collected from the second text files 222 of the second server 22 but also be edited by the users, thereby improving the accuracy of the information and adaptation of the change.

In summary, this invention can retrieve the extracted term from the first server and compare the extracted term with the second text files of the second server so as to obtain the desired generalized term, synonym and homonym information. Accordingly, this invention can improve the searching efficiency, thereby providing correct information with respect to the query term(s).

Although the invention has been described with reference to specific embodiments, this description is not meant to be construed in a limited sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for obtaining information, comprising:
a term creating unit for linking to a first server containing at least one first text file and analyzing the first text file to generate at least an extracted term;
a term mapping unit for linking to the term creating unit and a second server containing a plurality of second text files, and comparing the extracted term with the second text files to determine to execute a generalized term extraction procedure, a synonym extraction procedure, or a homonym extraction procedure so as to correspondingly generate generalized term information, synonym information or homonym information;
a database group linking to the term creating unit and the term mapping unit for storing the extracted term and the generated generalized term information, synonym information or homonym information; and
a user interface unit linking to the database group for receiving a query term, wherein when the query term matches the extracted term, the user interface unit provides the generalized term, synonym or homonym information.

2. A method for obtaining information, comprising steps of:
retrieving at least a first text file from a first server;
analyzing the first text file to generate at least an extracted term;
accessing a second server containing a plurality of second text files;
comparing the extracted term with the second text files; and
when at least one of the second text files contains the extracted term, executing a generalized term extraction procedure, a synonym extraction procedure, or a homonym extraction procedure so as to correspondingly generate generalized term information, synonym information or homonym information.

3. The method of claim 2, further comprising steps of:
when receiving a query term, comparing the query term to the extracted term to determine whether the query term matches the extracted term or not; and
when the query term matches the extracted term, providing the generalized term, synonym or homonym information.

4. The method of claim 2, wherein the first server is a news server, and the first text file is a source code file of a news webpage.

5. The method of claim 2, wherein the step of generating the extracted term comprises:
retrieving a text content of the first text file; and
executing a segmentation process with regarding to the text content of the first text file so as to generate the extracted term.

6. The method of claim 5, wherein the segmentation process comprises a lexicon segmentation method, a statistical segmentation method or a hybrid segmentation method.

7. The method of claim 2, wherein the second server is an open-edited information server, and the second text file is an editable information webpage.

8. The method of claim 2, further comprising steps of:
determining whether the extracted term contains a number in a Chinese word; and
if yes, executing the generalized term extraction procedure.

9. The method of claim 8, wherein when the text content of one of the second text files contains the extracted term, the generalized term extraction procedure comprises:
searching a location of the extracted term in the second text file;
determining whether at least one specific character exists behind the extracted term in the second text file;
if yes, determining whether the total number of the at least one specific character behind the extracted term matches the number in the Chinese word; and
when the total number of the at least one specific character behind the extracted term matches the number in the Chinese word, extracting the terms in front of and behind the specific character as the generalized term information.

10. The method of claim 9, wherein the specific character is a Chinese back sloping comma, and the step of determining whether the total number of the specific characters behind the extracted term matches the number in the Chinese word is to determine whether the total number of the terms in front of and behind the Chinese back sloping comma equals the number in the Chinese words minus one.

11. The method of claim 2, wherein when the text content of one of the second text files contains the extracted term, the synonym extraction procedure comprises:
searching a location of the extracted term in the second text file; and
extracting the first term of the paragraph containing the extracted term as the synonym information.

12. The method of claim 2, wherein when the text content of one of the second text files contains the extracted term, the synonym extraction procedure comprises:
searching a location of the extracted term in the second text file; and
extracting boldfaced words in the paragraph containing the extracted term as the synonym information.

13. The method of claim 2, wherein when the text content of one of the second text files contains the extracted term, the synonym extraction procedure comprises:
extracting a term located at a specific position in the second text file as the synonym information according to an editing rule of the second text file.

14. The method of claim 2, wherein when there are more than one of the second text files containing the extracted term, the homonym extraction procedure comprises:
processing the contents of the multiple second text files according to a term combination rule so as to generate the homonym information.

15. The method of claim 2, further comprising a step of:
modifying the generalized term, synonym or homonym information according to an agreement score.

16. The method of claim 2, further comprising a step of:
modifying the generalized term, synonym or homonym information according to an input content.

17. A method for obtaining information, comprising steps of:
receiving a query term; and
when the query term contains a number in a Chinese word, providing generalized term information obtained according to a generalized term extraction procedure.

18. The method of claim 17, further comprising a step of:
when the query term does not contain a number in a Chinese word, providing synonym information or homonym information obtained according to a synonym extraction procedure or a homonym extraction procedure.
